(19) United States
(12) Patent Application Publication
(10) Pub. No.: US 2003/0032899 A1
(43) Pub. Date: Feb. 13, 2003

(54) Ultrasonic cosmetic device

(75) Inventors: Takafumi Ohba, Hikone-shi (JP); Masayuki Hayashi, Hikone-shi (JP); Mahito Nunomura, Hirakata-shi (JP); Hideaki Abe, Neyagawa-shi (JP); Seiji Kaneko, Nerima-ku (JP)

Correspondence Address: GREENBLUM & BERNSTEIN, P.L.C., 1941 ROLAND CLARKE PLACE, RESTON, VA, 20191, US

(73) Assignee: Matsushita Electric Works, Ltd., Osaka (JP)

(21) Appl. No.: 10/201,993

(22) Filed: Jul. 25, 2002

(30) Foreign Application Priority Data
Jul. 26, 2001 (JP) 2001-225555

(51) Int. Cl. A61H 1/00

(52) U.S. Cl. 601/2

(57) ABSTRACT

An ultrasonic cosmetic device includes an ultrasonic oscillator having a specific thickness at the ultrasonic wave generating region, a probe equipped with an oscillating portion that connects to the ultrasonic oscillator through a joint surface, a horn that applies ultrasonic waves to the skin from a wave radiating surface, and a drive device to power the ultrasonic oscillator. The horn includes a restrictor portion in the form of an external circumferential component, the restrictor portion being located outside of the circumference of the ultrasonic oscillator to restrict the propagation of ultrasonic waves in undesired directions.

### BACKGROUND OF THE INVENTION

1. Field of the Invention

The invention relates to an ultrasonic cosmetic device incorporating an oscillating portion to which an ultrasonic oscillator is attached. The oscillating portion may be placed in contact with the face or other portions of the body to apply ultrasonic stimulation.

2. Discussion of Background Information

In recent years, ultrasonic cosmetic devices have come into widespread use. These devices often incorporate a horn at the tip of a probe, and an oscillating portion joined to an ultrasonic oscillator within the horn, the oscillating portion being put into contact with the skin of the face or other portion of the body as means of imparting ultrasonic stimulation. FIGS. 16a and 16b illustrate a conventionally structured ultrasonic cosmetic device. FIG. 16a is a side view of the complete ultrasonic cosmetic device; FIG. 16b is a cross sectional view of probe 3; and FIG. 16c is an enlarged cross sectional view of oscillating portion 10. The ultrasonic cosmetic device consists primarily of probe 3 and power unit 4 which drives ultrasonic oscillator 1 through lead wires 32 attached to electrodes 11. Probe 3 encloses vibrating portion 10 and includes radiating surface 22 which is placed in contact with the skin, horn 2 to which ultrasonic oscillator 1 is internally installed through horn joint surface 21, and housing 31 which is gripped by the person using the device. Ultrasonic waves radiating from surface 22 are applied to skin 20 through ultrasonic wave propagation media 15.

Ultrasonic oscillator 1 is made from a piezo effect ceramic or other similar material, and horn 2 is made from a metal such as aluminum. Horn 2 can be machined from aluminum or ferrous metal bar stock or draw formed from aluminum or ferrous metal sheet to form cylindrical plate member 23 as a portion of a chrome plated cap-like structure comprised of vertical wall 29 formed at the circumferential surfaces of plate member 23. Thickness TH2 of plate member 23 is established as an integral product of one half the wave length of the ultrasonic waves passing therethrough in order to propagate the efficient transmission of ultrasonic oscillations from ultrasonic oscillator 1. The longitudinal ultrasonic waves shown at the left of FIG. 16c show that thickness TH2 has been established as two times half the wave length of the ultrasonic waves within plate member 23.

FIGS. 17a and 17b show an internal view of horn 2 of the ultrasonic cosmetic device shown in FIGS. 16a-16c, and illustrate the propagation direction and amplitude of the ultrasonic oscillations. FIG. 17a is a plan view; and FIG. 17b is a cross section. In FIG. 17b the amplitude of the propagating ultrasonic oscillations is denoted by the size of the arrows, and the direction of the ultrasonic oscillations by the arrow direction. The ultrasonic oscillations applied to joint surface 21 from ultrasonic oscillator 1 propagate directly toward radiating surface 22 of horn 2 to effective component 51 that can be seen in the central lower region of the figure, and to ineffective component 52 (termed parasitic oscillation) where the vectors show the oscillation propagation direction around the circumference of oscillator 1. Effective component 51 applies ultrasonic oscillations (ultrasonic stimulation) to skin 20 (as shown in FIGS. 16a-16c) by means of the oscillations emitted from radiating surface 22 of horn 2. The majority of ineffective component 52 do not radiate oscillations to surface 22, so these oscillations are not propagated to skin 20. Thus, the presence of ineffective component 52 (parasitic oscillation) lowers ultrasonic wave propagation efficiency.

If horn 2 is designed within severe dimensional restrictions (specifically, a design that carefully considers the thickness of vertical wall 29 and the region were plate member 23 joins vertical wall 29), that is to say, if horn 2 is designed to an extremely specific shape which requires highly precise forming processes to manufacture, the parasitic oscillations of ineffective component 52 can be reduced.

The present invention, taking the above mentioned factors into consideration, provides an ultrasonic cosmetic device able to restrict parasitic oscillations through a horn structure that does not require an extremely specific shape nor the use of highly precise manufacturing processes for its manufacture.

### SUMMARY OF THE INVENTION

The ultrasonic cosmetic device of the present invention may include an ultrasonic oscillator having a specific thickness at the ultrasonic wave generating region, a probe equipped with an oscillating portion that connects to the ultrasonic oscillator thróugh a joint surface, a horn that applies ultrasonic waves to the skin from a wave radiating surface, and a drive device to power the ultrasonic oscillator, wherein the horn incorporates a restrictor portion in the form of an external circumferential shaped component, the restrictor portion being located externally to the circumference of the ultrasonic oscillator, to restrict the propagation of ultrasonic waves in the radial direction.

The use of the restrictor portion at the external circumference of the ultrasonic oscillator acts to restrict the propagation of ultrasonic waves in the radial direction, thus restricting parasitic oscillations without the need to fabricate the horn to a highly specific shape.

The ultrasonic cosmetic device may further include a restrictor portion fabricated from a material having an ultrasonic wave propagation restriction property (which may take the form of ultrasonic wave absorption or reflection properties) that functions to restrict the propagation of ultrasonic waves in the radial direction.

In the ultrasonic cosmetic device of the present invention, the ultrasonic oscillator may be formed having a thickness approximately equal to the product of an integer times half the ultrasonic wave length propagated in the ultrasonic oscillator. Moreover, the horn may be formed having a thickness that is approximately equal to the product of an integer times half the ultrasonic wave length propagated in the horn.

Standing ultrasonic waves are formed within the ultrasonic oscillator as a result of the thickness of the oscillator being established as a product of an integer times half the ultrasonic wave length, and standing ultrasonic waves are formed within the horn as a result of the horn thickness being established as the product of an integer times half an ultrasonic wave length propagated within the horn. The result is improved ultrasonic wave propagation efficiency.

The ultrasonic cosmetic device may further include a drive device that generates a longitudinal oscillation frequency in the thickness direction of the ultrasonic oscillator and horn, thus forming a mechanism that increases ultrasonic wave propagation efficiency.

The horn may be equipped with a flat, plate member that incorporates a joint surface and radiating surface, thus providing a structure that allows the horn to be easily fabricated. The horn may be equipped with a flat, plate member around which an annular vertical wall is formed. The existence of an annular vertical wall located around the plate member allows the horn to be secured to the housing without restricting ultrasonic oscillations at the plate member at the time when the user is gripping the housing and holding the horn in contact with the skin.

The restrictor portion may be provided as a thin wall portion created by a channel portion located at at least one location on the horn. As a result, this structure establishes a high resonance frequency in the thin wall portion that restricts the propagation of ultrasonic oscillations from the ultrasonic oscillator. Moreover, establishing the thickness of the thin wall portion to a dimension that does not allow the passage of frequencies whose wave length is the approximate product of an integer times one fourth the wave length of the ultrasonic waves in the plate member also forms a mechanism able to restrict propagation of ultrasonic harmonics.

The channel portion may incorporate an inner extremity that is approximately hemispherical in cross section, thus establishing the thin wall portion as a non-uniform thickness that is not conducive to the formation of standing waves. This structure forms a mechanism through which the thin wall portion is able to restrict all ultrasonic oscillation frequencies. The channel portion may be filled with a material having an audio impedance characteristic that differs from that of the horn material. The difference in material characteristics results in the restriction of the propagation of ultrasonic oscillations, at the horn portion, from the ultrasonic oscillator. Moreover, this type of structure prevents the invasion of foreign objects that may possess properties encouraging the propagation of ultrasonic oscillation.

The restrictor portion may be formed as a thick wall portion in the form of a flange portion on the joint surface of the horn. The thick wall portion reduces resonance frequencies at the flange portion region and restricts the propagation of ultrasonic oscillation from the ultrasonic oscillator. The flange portion forms a thick wall portion dimensioned to a thickness that prevents the passage of ultrasonic frequencies that are the approximate product of an integer times one fourth the wave length of ultrasonic waves propagated in the thick wall portion, thus forming a mechanism that also restricts the propagation of ultrasonic harmonics.

The flange portion may have an upper extremity that is approximately hemispherical in cross section, thus resulting in a non-uniform thickness of the thick portion as a shape that is not conducive to the formation of standing waves. This structure forms a mechanism through which all ultrasonic oscillation frequencies are restricted.

The horn may have a flat plate member on which is formed a joint surface and a radiating surface, and having the flange portion integrally formed to the aforesaid vertical annular wall which is located around the circumference of the plate member. The existence of the annular vertical wall located around the circumference of the plate member allows the horn to be secured to the housing without restricting ultrasonic oscillations at the plate member at the time when the user is gripping the housing and holding the horn in contact with the skin. Moreover, the horn is easily fabricated as a result of the vertical annular wall and flange portion being formed as an integrated one-piece structure.

The oscillating center of the ultrasonic oscillator and the center of the horn may be in approximate alignment which results in maximum amplitude at the center region of the horn. When the ultrasonic cosmetic device is used and the center region of the horn brought into contact with the skin, the region of greatest amplitude contacts with the skin with the result that ultrasonic stimulation can be applied to the skin with a high level of efficiency.

The center of the ultrasonic oscillator and the center of the horn may be in approximate mutual alignment. The device is further characterized by electrodes formed on surfaces of the ultrasonic oscillator opposing the oscillator thickness direction, to supply the oscillator with electrical power, through wire leads, from a drive device. One electrode is formed as a wrap-around electrode incorporating a wrap-around portion that extends from one electrode surface to the other in a symmetrical pattern in relation to the central axis of the oscillator.

The structure in which the ultrasonic oscillator is equipped with surface electrodes located on an electrode surface opposite to the thickness direction of the oscillator, the oscillator supplied with electrical power from the drive device through electrical lead wires and surface electrodes, and the wrap-around electrode extending from one electrode surface of the oscillator to the opposing electrode surface, enables the center of the ultrasonic oscillator to be approximately aligned with its oscillating center and the center of the oscillator to be approximately aligned with the center of the horn, thus providing a mechanism through which ultrasonic stimulation can be applied to the skin with a high level of efficiency.

The connections between the electrodes and lead wires may be located in the region of the outer circumference of the ultrasonic oscillator. Connecting the electrodes and lead wires at this location results in a low oscillation amplitude at the connections, thus providing a structure that helps prevent the wire leads from separating from the electrodes.

The ultrasonic cosmetic device may include electrodes formed on the surfaces opposing the thickness direction of the ultrasonic oscillator to supply the oscillator with electrical power, through lead wires, from a drive device. The connection points between the wire leads and electrodes are established within the inner side of a channel extending radially inward from the aforesaid annular channel portion.

This structure, in which a wire lead is connected to an electrode located adjacently to the inner wall of an annular channel portion, eliminates the need for a wrap-around type of electrode. If a wrap-around type of electrode were to be employed, ultrasonic oscillations would not be generated within the wrap-around portion of the electrode. Compared to a wrap-around electrode structure, this electrode structure is able to increase the effective oscillation surface area of the ultrasonic oscillator.

The ultrasonic cosmetic device may further include a damper piece fixedly installed to the ultrasonic oscillator on the side of the oscillator opposing the horn contact side. This structure, through which a damper piece is attached to the ultrasonic oscillator at the surface opposite to the horn joint surface, is able to restrict the propagation of ultrasonic waves from the damper piece side of the oscillator, thus concentrating the propagation of ultrasonic waves on the horn side and increasing oscillation efficiency.

The ultrasonic cosmetic device may include electrodes formed on oscillator surfaces opposing the thickness direction of the ultrasonic oscillator, to supply the oscillator with electrical power, through lead wires, from a drive device, whereby one electrode includes a wrap-around electrode that extends from one oscillator electrode surface to the other, and whereby the connections between the electrode and wire lead are located adjacent to the inner wall of a region connecting to and extending radially inward from an annular channel portion.

This structure, whereby one electrode includes a wrap-around electrode that extends from one oscillator electrode surface to the other, and whereby the connection between the electrode and wire lead is located adjacent to the inner wall of the annular concave portion in an area extending radially inward from the channel, provides for a structure through which the electrode and wire lead connections can be located on the horn contact side of the ultrasonic oscillator, thereby making it possible to reduce the thickness of the oscillator and design the ultrasonic cosmetic device to more compact dimensions.

An aspect of the present invention includes an ultrasonic cosmetic device including an ultrasonic oscillator having a thickness at an ultrasonic wave generating region, a horn that provides ultrasonic waves from a wave radiating surface, a probe having an oscillating portion including the horn, the horn being connected to the ultrasonic oscillator through a joint surface, and a drive device that drives the ultrasonic oscillator, wherein the horn includes a restrictor portion, the restrictor portion including an external circumferential component located outside of a circumference of the ultrasonic oscillator, the restrictor portion restricting propagation of ultrasonic waves. The restrictor portion may be constructed of a material that has ultrasonic wave propagation restriction properties. The thickness of the ultrasonic oscillator may be approximately the product of an integer times half the ultrasonic wave length propagated in the ultrasonic oscillator, and the thickness of the horn may be approximately the product of an integer times half the ultrasonic wave length propagated in the horn.

In a further aspect of the present invention, the drive device may generate a longitudinal oscillation frequency in the thickness direction of the ultrasonic oscillator and the horn. The horn may include a flat plate member including the joint surface and a radiating surface. The horn may include a flat plate member including the joint surface, a radiating surface, and an annular vertical wall formed at an outer circumferential region of the flat plate member. The restrictor portion may be configured as a thin wall portion formed by a channel portion provided at at least one location on the horn. The ultrasonic cosmetic device may include an edge of the channel portion is shaped as an approximate hemisphere.

In a further aspect of the present invention, the channel portion may be filled with a material having an acoustic impedance characteristic different from that of the horn material. In the ultrasonic cosmetic device, the restrictor portion may be configured as a thick wall portion created by a flange portion formed on the joint surface. The edge of the flange portion is formed in an approximate hemispherical shape. Further, the horn may include a flat plate member having a joint surface and a radiating surface, and may include the flange portion formed as an integral portion of the vertical annular wall located around the circumference of the plate member. The oscillation center of the ultrasonic oscillator and the center of the horn are in approximate alignment.

Further, an aspect of the present invention may include an ultrasonic cosmetic device in which the center of the ultrasonic oscillator and the center of the horn are in approximate alignment, electrodes are provided on opposing electrode surfaces of the ultrasonic oscillator in the thickness direction to supply the oscillator with electrical power through wire leads from the drive device, and one electrode is formed as a wrap-around electrode including a wrap-around portion that extends from one electrode surface to another opposing electrode surface, and which is symmetrically shaped in relation to the central axis of the oscillator. The connections between the electrodes and lead wires may be located in an outer circumferential region of the ultrasonic oscillator. The electrodes may be provided on opposing surfaces of the ultrasonic oscillator in the thickness direction to supply the oscillator with electrical power through lead wires, and the connecting points between the electrodes and wire leads are located adjacent to an inner wall of a channel connecting to and extending radially inward from the annular channel portion. The ultrasonic cosmetic device may include a damper fixed to the ultrasonic oscillator on a side of the oscillator opposite to the horn joint surface side.

In a further aspect of the present invention, the ultrasonic cosmetic device may include electrodes formed on oscillator surfaces opposing the thickness direction of the ultrasonic oscillator to supply the oscillator with electrical power through lead wires from a drive device, and wherein one electrode includes a wrap-around electrode that extends from one electrode surface to another, and the connections between the electrodes and wire leads may be located adjacent to an inner wall of a channel connecting to and extending radially inward from the annular channel portion.

### BRIEF DESCRIPTION OF THE DRAWINGS

The above, and other objects, features and advantages of the present invention will be made apparent from the following description of the preferred embodiments, given as nonlimiting examples, with reference to the accompanying drawings in which:

FIG. 1a is a plan view of a first embodiment of the ultrasonic cosmetic device of the present invention showing the horn; FIG. 1b is a cross sectional view of the horn according to the embodiment of FIG. 1a, showing internal horn structure that propagates ultrasonic oscillations;

FIG. 2a is a graph showing the impedance characteristics of a conventional oscillator; FIG. 2b is graph showing the impedance characteristics of the horn according to the present invention;

FIG. 3a is a plan view of the horn, according to a second embodiment of the present invention; FIG. 3b is a cross sectional view of the horn according to the embodiment of FIG. 3a, showing internal horn structure and propagation direction and amplitude of the ultrasonic oscillations within the internal horn structure;

FIG. 4a shows the oscillation direction of the oscillating portion, according to a third embodiment of the present invention; FIG. 4b shows an oscillating portion with a reduced dimension, according to the embodiment of FIG. 4a; and FIG. 4c shows an oscillating portion with an increased dimension, according to the embodiment of FIG. 4a;

FIG. 5a is a plan view of a horn, according to a fourth embodiment of the present invention; FIG. 5b is a cross sectional view of the horn, according to the embodiment of FIG. 5a;

FIG. 6a is a plan view of a horn, according to a fifth embodiment of the present invention; FIG. 6b is a cross sectional view of the horn, according to the embodiment of FIG. 6a, showing internal horn structure and propagation direction and amplitude of the ultrasonic oscillations within the internal horn structure;

FIGS. 7a and 7b are cross sectional views of the concave portion of the horn according to a sixth embodiment of the present invention; FIG. 7c is a cross sectional view of the channel portion of the horn having a chamfered portion, according to the embodiment of FIG. 7a; FIGS. 7d and 7e are cross sectional views of the channel portion of the horn having a filling material, according to the embodiment of FIG. 7a;

FIG. 8a is a plan view of a horn according to a seventh embodiment of the present invention; FIG. 8b is a cross section view of the horn, according to the embodiment of FIG. 8a, showing internal horn structure and propagation direction and amplitude of the ultrasonic oscillations within the internal horn structure;

FIG. 9a is a cross sectional view of the convex portion of the horn of an eighth embodiment of the present invention; FIG. 9b is a cross sectional view of the horn having flange portions of various heights, according to the embodiment of FIG. 9a; FIG. 9c is a cross sectional view of the flange portion of the horn having a hemispherical shape at upper and lower extremities, according to the embodiment of FIG. 9a; FIG. 9d is a cross sectional view of the flange portion of the horn being formed integral with a vertical wall, according to the embodiment of FIG. 9a;

FIG. 10a is a plan view of an ultrasonic oscillator electrode structure and joint surface between the ultrasonic oscillator and horn according to a ninth embodiment of the present invention; FIG. 10b is a cross sectional view of the ultrasonic oscillator electrode structure according to the embodiment of FIG. 10a;

FIG. 11a is a plan view of an ultrasonic oscillator electrode structure and joint surface between the ultrasonic oscillator and horn according to a tenth embodiment of the present invention; FIG. 11b is a cross sectional view of the ultrasonic oscillator electrode structure according to the embodiment of FIG. 11a;

FIG. 12a is a plan view of an eleventh embodiment of the present invention illustrating the oscillator electrode structure and the connection locations between the electrodes and lead wires; FIG. 12b is a cross sectional view of the ultrasonic oscillator electrode structure according to the embodiment of FIG. 12a;

FIG. 13a is a plan view of a twelfth embodiment of the present invention illustrating the oscillator electrode structure and the connection locations between the electrodes and lead wires; FIG. 13b is a cross sectional view of the ultrasonic oscillator electrode structure according to the embodiment of FIG. 13a;

FIG. 14a is a plan view of a thirteenth embodiment of the present invention illustrating the oscillator structure; FIG. 14b is a cross sectional view of the oscillator structure according to the embodiment of FIG. 14a;

FIG. 15a is a plan view of a fourteenth embodiment of the present invention illustrating the oscillator electrode structure and the connection locations between the electrodes and lead wires; FIG. 15b is a cross sectional view of the oscillator electrode structure according to the embodiment of FIG. 15a;

FIGS. 16a, 16b, and 16c show the structure of a conventional ultrasonic cosmetic device; and

FIG. 17a is a plan view of a conventional ultrasonic cosmetic device; FIG. 17b is a cross sectional view of the conventional ultrasonic cosmetic device of FIG. 17a, illustrating the propagation direction and amplitude of ultrasonic oscillations within the internal horn structure.

### DETAILED DESCRIPTION OF THE PRESENT INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

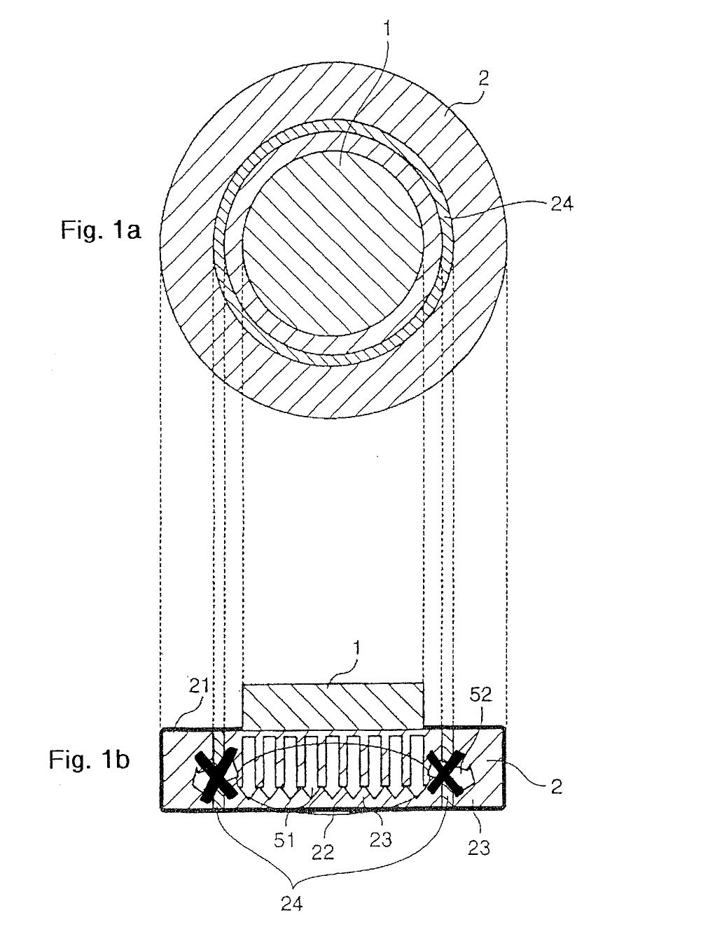

FIGS. 1a and 1b illustrate a first embodiment of the ultrasonic cosmetic device of the present invention. FIG. 1b illustrates the direction and amplitude of the ultrasonic oscillations propagated in horn 2. FIG. 1a is a plan view; and FIG. 1b is a cross sectional view. The amplitude and propagation direction of the ultrasonic oscillations in horn 2 (FIG. 1b) are respectively shown by the size of the arrows and their directions. Horn 2 is constructed of plate member 23 through which ultrasonic waves generated by ultrasonic oscillator 1 are applied to the skin, and restrictor portion 24, which includes an external ring shaped or circumferential component, is installed around the perimeter of ultrasonic oscillator 1 to restrict the propagation of ultrasonic waves in the radial direction.

As shown by the arrows in FIG. 1b, ultrasonic oscillations travel from ultrasonic oscillator 1 to the internal area of horn 2 (plate member 23) through joint surface 21, and are applied to skin 20 from radiation surface 22 through effective component 51 only. Ineffective component 52 (called parasitic oscillations), which includes the component in which the propagation vectors move in the external radial direction from ultrasonic oscillator 1, contains restrictor portion 24 that prevents the propagation of ultrasonic oscillations beyond the perimeter of restrictor portion 24. This structure acts as a mechanism to prevent parasitic oscillations. In FIG. 1b, the “X” marks overlapping the arrows 52 indicate that the restrictor portion 24 has prevented the propagation of ultrasonic oscillations in the radial direction.

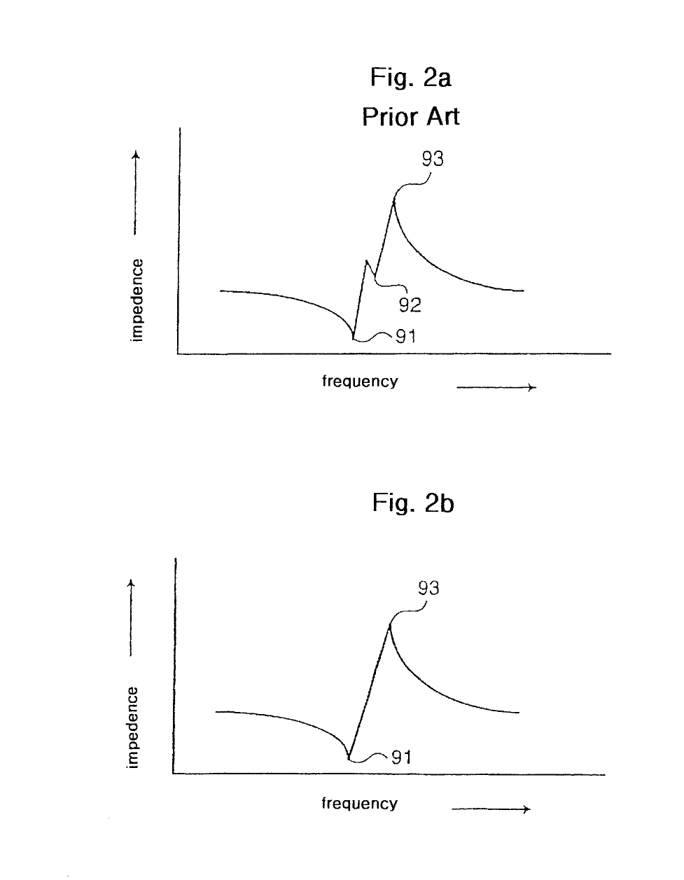

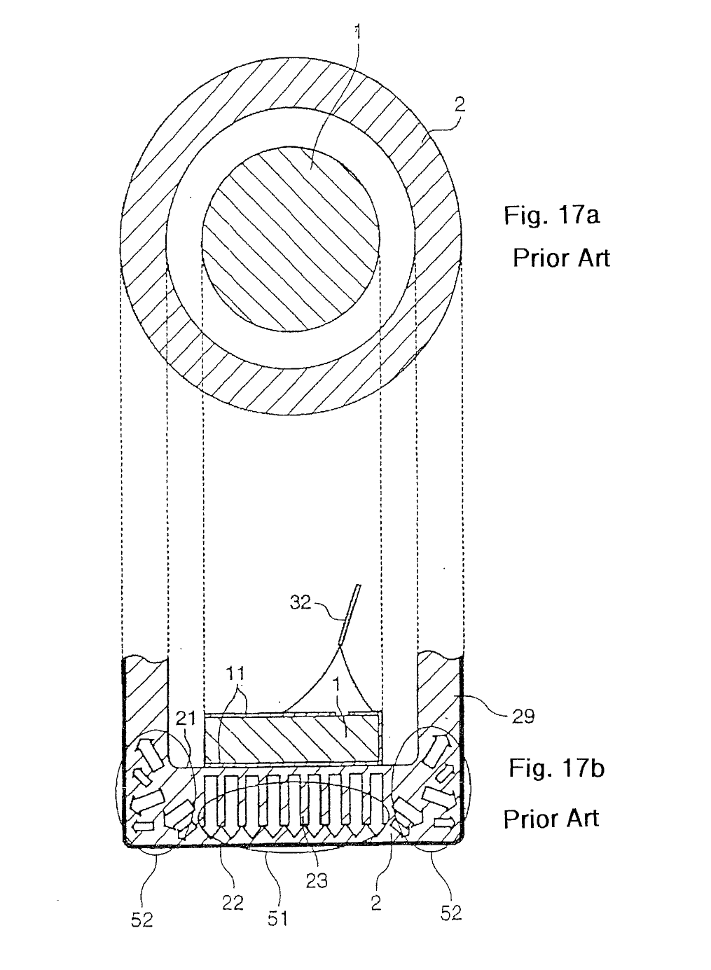

FIG. 2a and 2b present graphs illustrating the impedance characteristics of conventional oscillator 10 (FIG. 17) and in horn 2 (FIG. 1) of the present invention, respectively. Frequency is shown on the horizontal axis and impedance on the vertical axis. FIG. 2a shows the impedance characteristics of conventional oscillator 10, and FIG. 2b the impedance characteristics of oscillator 10 as applied in the present invention. As shown in FIG. 2a, the impedance characteristics of conventional oscillator 10 show a parasitic oscillation, as described previously in regard to oscillation propagation in internal area of horn 2, in the form of resonance 91 at the point of lowest impedance, resonance 93 at the point of highest impedance, and sub-resonance 92 which occurs at an extremely small impedance value. Sub-resonance 92 is generated in addition to resonance 91 in a case where drive device 34 is structured as a self-exciting oscillating circuit, thus resulting in an unstable propagation pattern of ultrasonic oscillations applied to skin 20 from horn 2. FIG. 2b illustrates the impedance characteristics of oscillator 10 of the present invention in which sub-resonance 92, which occurs at an extremely small impedance, has been eliminated due to the restriction of parasitic oscillation in horn 2 as explained previously. Because sub-resonance point 92 does not exist as an impedance characteristic of the present invention, resonance 91 is generated as a stable resonance even when drive device 4 is structured as a self-exciting oscillator circuit, thus providing for a stable ultrasonic oscillation pattern propagated from horn 2 to skin 20.

Parasitic oscillations are prevented because restrictor portion 24 is constructed of a material that restricts the propagation of ultrasonic oscillations and is installed around the external perimeter of ultrasonic oscillator 1. The result is that ultrasonic wave propagation efficiency is increased and the formation of an unstable propagation pattern prevented for the ultrasonic waves moving from horn 2 to skin 20. Furthermore, horn 2 is easy to fabricate as a result of being structured as a plate member.

While this embodiment describes the structure of restrictor portion 24 as surrounding the external perimeter of ultrasonic oscillator 1, restrictor portion 24 may also be structured as an integral portion of the external perimeter of ultrasonic oscillator 1. Moreover, while this embodiment describes the thickness of restrictor portion 24 as being approximately the same as that of horn 2 (plate structure 23), the thickness dimension of these two components may mutually differ.

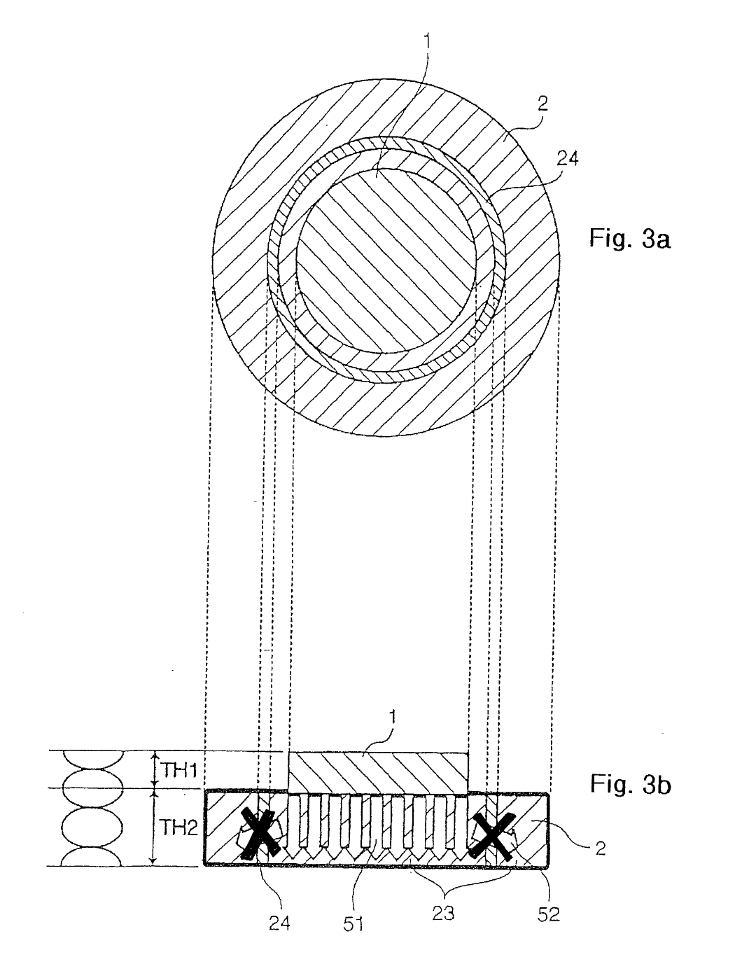

The structure of the ultrasonic cosmetic device of the present invention as described in the second embodiment is similar to the structure of the first embodiment. FIGS. 3a and 3b illustrate the structure of horn 2 and the propagation direction and amplitude of the ultrasonic oscillations within horn 2. FIG. 3a is a plan view and FIG. 3b is a cross sectional view. In FIG. 3b, the “X” marks overlapping the arrows 52 indicate that the restrictor portion 24 has prevented the propagation of ultrasonic oscillations in the radial direction. The left side of FIG. 3b illustrates the shape of the ultrasonic waves (standing waves which are shown in a horizontal format for convenience of explanation) propagated in oscillating portion 10. Thickness TH1 of ultrasonic oscillator 1 is established as approximately the product of an integer (in this case the integer equals 1) times half the wavelength of the ultrasonic waves propagated within ultrasonic oscillator 1. Likewise, thickness TH2 of horn 2 is also established as approximately the product of an integer (in this case the integer equals 2) times half the wavelength of the ultrasonic waves propagated within horn 2 (plate member 23).

Establishing thickness TH1 of ultrasonic oscillator 1 and thickness TH2 of horn 2 (plate member 23) as products of an integer times half the wave length of the ultrasonic waves propagated therein (a integer 1 for oscillator 1; and an integer 2 for horn 2) results in the formation of standing ultrasonic waves within horn 2 (plate member 23) and a resultant increase in ultrasonic wave propagation efficiency.

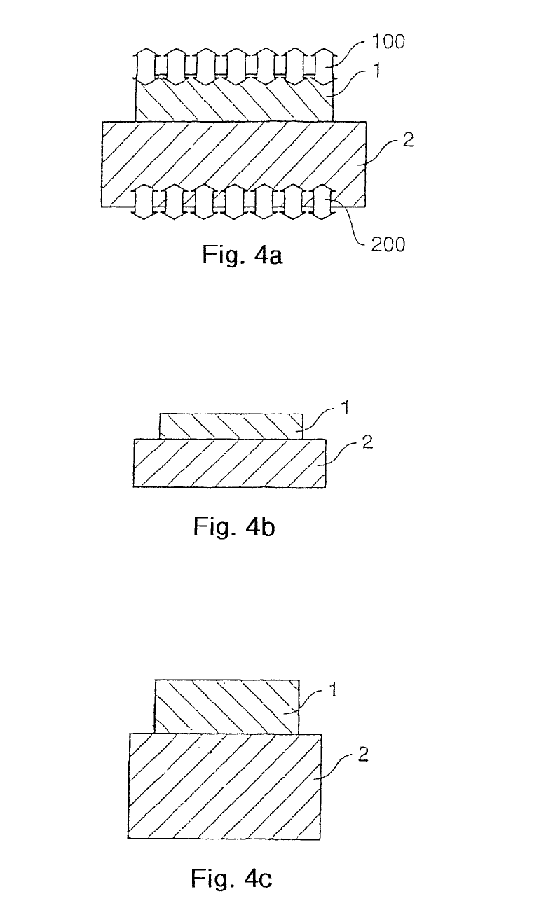

The structure of the ultrasonic cosmetic device invention as described in a third embodiment of the present invention is similar to the structure of the first embodiment except that the drive frequency emanating from drive device 4 is propagated in the thickness direction of ultrasonic oscillator 1 and horn 2 as a longitudinally frequency oscillation. FIGS. 4a, 4b, and 4c provide an illustration of the mechanical oscillations of oscillating portion 10 as described by the third embodiment of the ultrasonic cosmetic device of the present invention. FIG. 4a shows the oscillation direction, FIG. 4b shows oscillating portion 10 with a reduced dimension in the thickness direction, and FIG. 4c shows oscillating portion 10 with an enlarged dimension in the thickness direction. Due to the frequency emanating from drive device 4 being a longitudinally oscillating frequency in relation to the thickness direction of ultrasonic oscillator 1 and horn 2, ultrasonic oscillator 1 and horn 2 are longitudinally oscillated in their thickness direction as shown in FIG. 4a. That is, the oscillations cyclically repeat, in the thickness direction, through the reduced or expanded dimensions of ultrasonic oscillator 1 and horn 2 as shown in FIGS. 4b and 4c respectively.

Ultrasonic wave propagation efficiency is increased from oscillator 1 to horn 2 because ultrasonic oscillator 1 and horn 2 oscillate longitudinally (in their thickness direction).

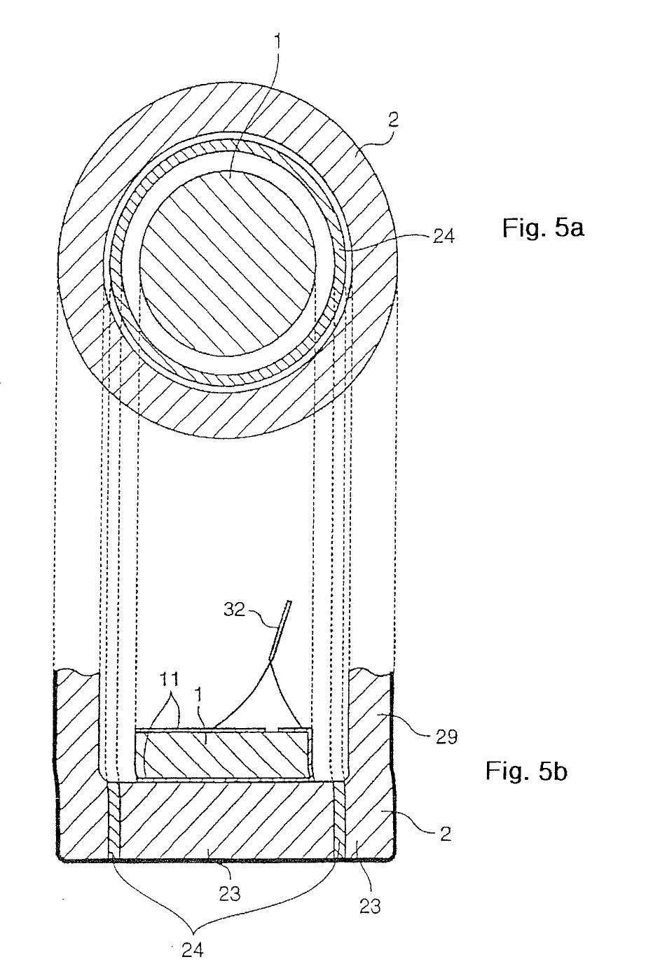

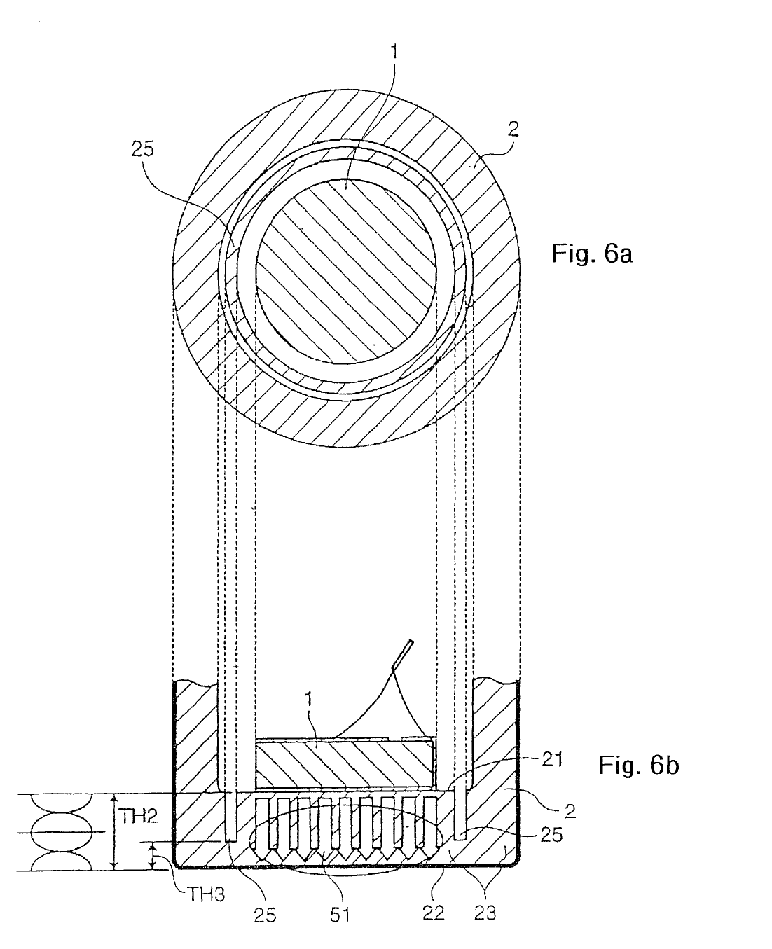

The structure of the ultrasonic cosmetic device of the present invention in a fourth embodiment is, excluding the shape of horn 2, similar to that of the second embodiment. FIGS. 5a and 5b illustrate the structure of horn 2 of the fourth embodiment of the ultrasonic cosmetic device of the present invention. Horn 2 is a cap-like structure constructed of approximately cylindrical plate member 23 through which ultrasonic waves are applied to skin 20, and vertical annular wall 29 extending upward from the perimeter of plate member 23.

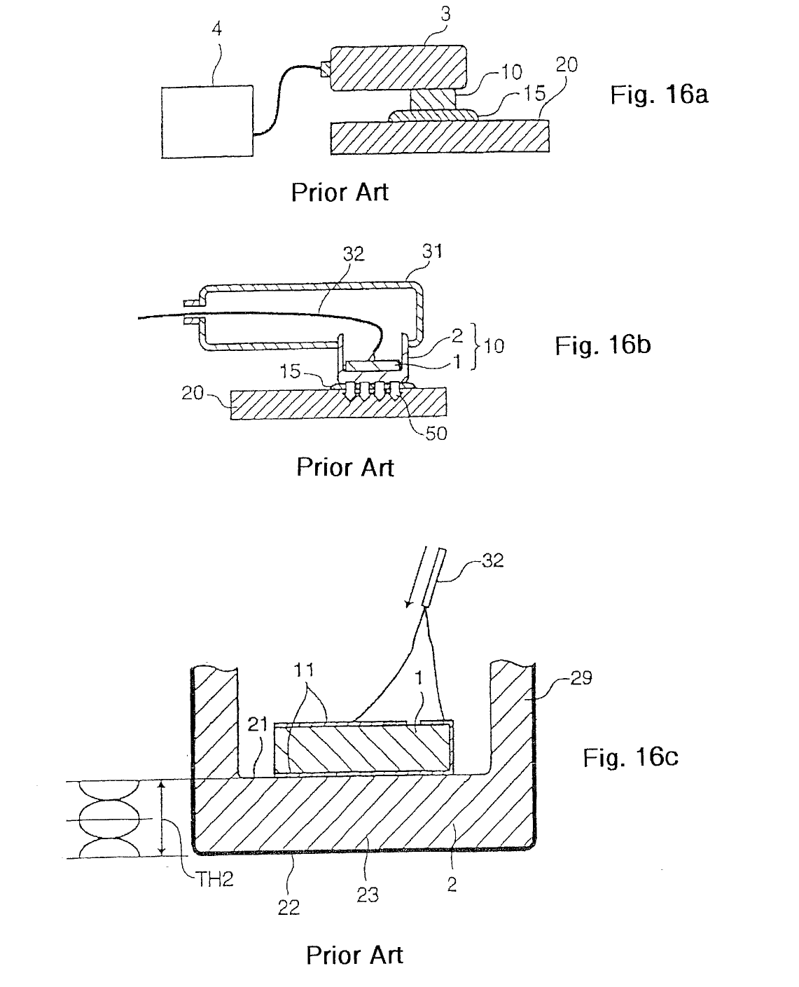

Due to the existence of vertical wall 29, horn 2 can be secured to grip housing 31 (FIG. 16), which is gripped by the user to as means of pressing horn 2 against skin 20, without plate member 23 restricting ultrasonic waves.

The structure of the ultrasonic cosmetic device of the present invention in a fifth embodiment is, excluding the shape of horn 2, similar to that of the fourth embodiment. FIGS. 6a and 6b illustrate the structure of horn 2 and the direction and amplitude of the ultrasonic oscillations propagated therein. FIG. 6a is a plan view and FIG. 6b is a cross sectional view. In FIG. 6b, the ultrasonic oscillations within horn 2 are indicated by the size of the arrows, and their propagation direction by the direction indicated by the arrows. Horn 2 is constructed of plate member 23 through which ultrasonic oscillations from ultrasonic oscillator 1 are conveyed to the skin, and channel portion 25 (equivalent to the aforesaid restrictor portion) which is provided to at least one portion of the external perimeter of ultrasonic oscillator 1. Because the thickness of plate member 23 is reduced at the area adjacent to channel portion 25, there is a high resonance frequency that restricts the propagation of ultrasonic oscillations from ultrasonic oscillator 1. Furthermore, thickness TH3, which is the thickness of plate member 23 at channel portion 25, is formed to a dimension that prevents the passage of ultrasonic frequencies that are the approximate product of an integer times one fourth the wave length of ultrasonic waves propagated in plate member 23, thus also restricting the propagation of ultrasonic harmonics.

Accordingly, as shown by the arrows in FIG. 6b, the ultrasonic oscillations from ultrasonic oscillator 1 are conveyed to plate member 23 from joint surface 21 on plate member 23, and radiated to skin 20 from radiation surface 22 only by means of effective component 51. The ineffective component (parasitic oscillation), a component that includes the vectors showing propagation in the external diametric direction from ultrasonic oscillator 1, is not propagated because it is restricted by the portion of plate member 23 (thin wall portion) adjacent to channel portion 25. This structure has the effect of eliminating parasitic oscillations.

Moreover, in the same way as the aforesaid ineffective component (parasitic oscillation) within the ultrasonic oscillations from oscillator 1 is restricted by plate member 23 at channel portion 25, oscillations applied to the external portion of horn 2 (plate member 23) at channel portion 25 (the thin wall portion of plate member 23) are not propagated within ultrasonic oscillator 1. As a result, while oscillations may be externally applied to ultrasonic oscillator 1, damage to drive circuit 4 (which supplies a voltage to ultrasonic oscillator 1, see FIG. 16) is prevented.

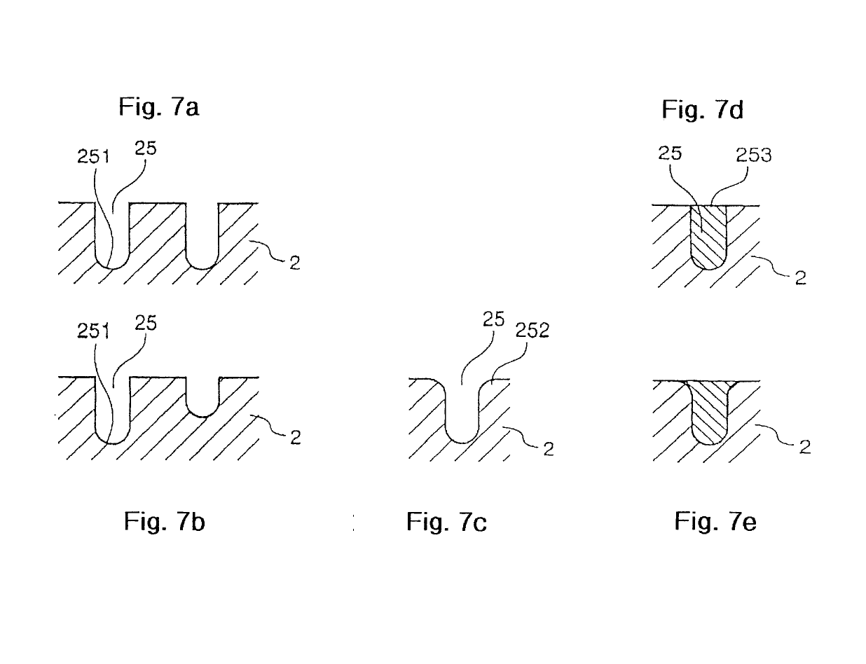

The structure of the ultrasonic cosmetic device of the present invention in a sixth embodiment is, excluding the shape of channel portion 25 of horn 2 (plate member 23), essentially similar to that put forth in the fifth embodiment. FIGS. 7a-7e are cross sectional views of channel portion 25 of horn 2 as described in this sixth embodiment. FIG. 7a illustrates extremity 251 of channel portion 25 as being formed to an approximate hemispherical shape. Parasitic oscillation does not result in the formation of standing waves due to the non-uniform thickness of plate member 23 (thin wall portion) . Accordingly, ultrasonic oscillations at all frequencies are prevented at the region of plate member 23 adjacent to channel portion 25 (thin wall portion). Furthermore, channel portion 25 may be provided at multiple locations in plate member 23, as shown in FIG. 7a, and each channel portion may be formed at a varying depth to form a varying thickness of the thin wall portion of plate member 23, as shown in FIG. 7b.

FIG. 7c illustrates a configuration of channel portion 25 in which upper edge 252 of channel portion 25 is chamfered in addition to lower portion 251 being formed to an approximate hemispherical shape. FIGS. 7d and 7e illustrate configurations in which channel portion 25 is filled with a material (i.e. silicon rubber) having a different acoustic impedance characteristic than that of the material (i.e. aluminum) from which horn 2 (plate member 23) is made. These configurations prevent the invasion of foreign objects, which may have ultrasonic oscillation propagation properties, into channel portion 25.

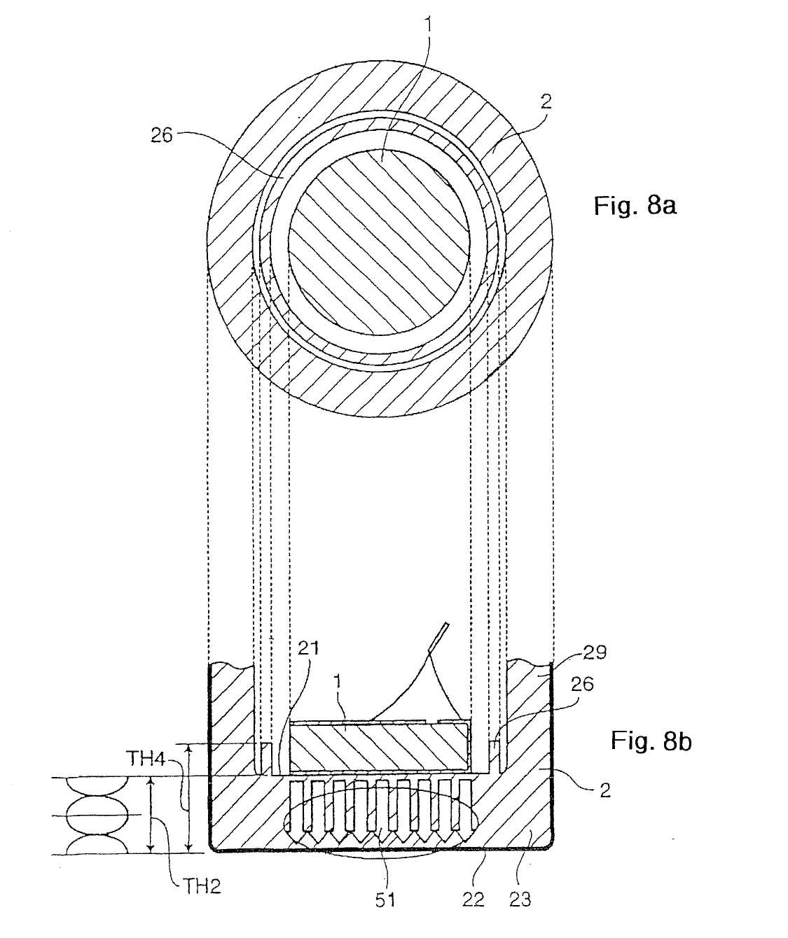

The structure of the ultrasonic cosmetic device of the present invention in a seventh embodiment is, excluding horn 2, similar to that put forth in the fourth embodiment. FIGS. 8a and 8b illustrate the structure of horn 2 and the propagation direction and amplitude of the ultrasonic oscillations within horn 2. FIG. 8a is a plan view and FIG. 8b is a cross sectional view. In FIG. 8b, the amplitude of the propagating ultrasonic vibrations is denoted by the size of the arrows, and the direction of the ultrasonic oscillations is shown by the direction in which the arrows point. Horn 2 includes a plate member 23 which conveys ultrasonic waves from ultrasonic oscillator 1 to the skin, and at least one flange portion 26 (equivalent to the aforesaid restrictor portion) formed around the external perimeter of ultrasonic oscillator 1. The resonant frequency is lowered and the propagation of ultrasonic oscillations from ultrasonic oscillator 1 is restricted due to the thickness of plate member 23 (thick wall portion) increasing at flange portion 26 (restrictor portion). Furthermore, thickness TH4, which is the thickness of plate member 23 formed by flange portion 26, is formed to a dimension that prevents the passage of ultrasonic frequencies that are the approximate product of an integer times one fourth the wave length of ultrasonic waves propagated in plate member 23, thus also restricting the propagation of ultrasonic harmonics.

Accordingly, as shown by the arrows in FIG. 8b, the ultrasonic oscillations from ultrasonic oscillator 1 are conveyed to plate member 23 from joint surface 21 on plate member 23, and radiated to skin 20 from radiation surface 22 only by means of effective component 51. The ineffective component (parasitic oscillation), a component that includes the vectors showing propagation in the external diametric direction from ultrasonic oscillator 1, is not propagated because it is restricted by the portion of plate member 23 (thick wall portion) adjacent to flange portion 26. In other words, this structure is able to prevent parasitic oscillations.

Moreover, in the same way as the aforesaid ineffective component (parasitic oscillation) of the ultrasonic oscillations from oscillator 1 is restricted by plate member 23 at flange portion 26, oscillations applied to the external portion of horn 2 (plate member 23) at flange portion 26 (thick wall portion) are not conveyed to ultrasonic oscillator 1. As a result, while oscillations may be externally applied to ultrasonic oscillator 1, damage to drive circuit 4 (which supplies a voltage to ultrasonic oscillator 1, see FIG. 16) is prevented.

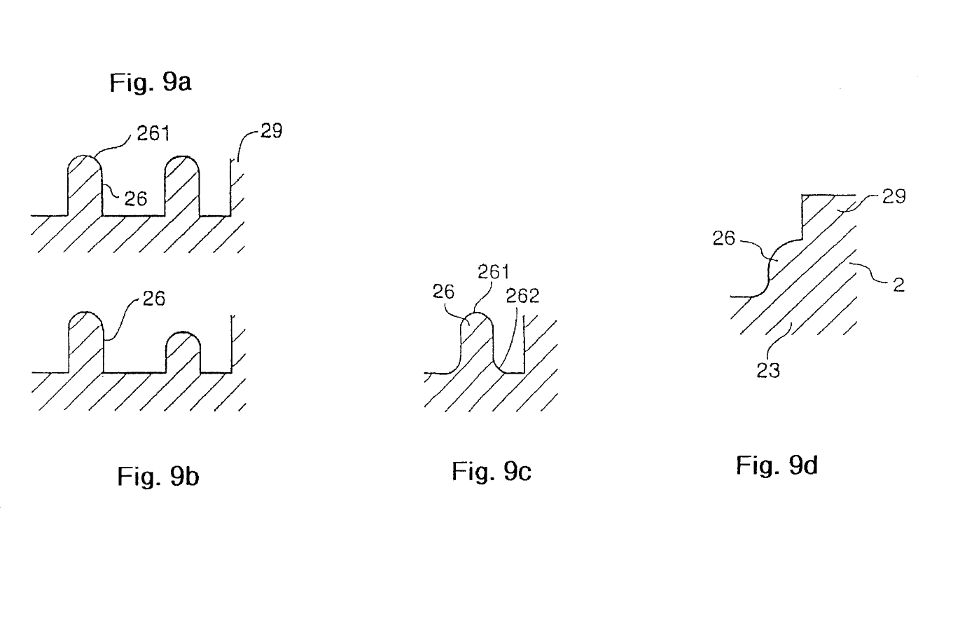

The structure of the ultrasonic cosmetic device of the present invention in an eighth embodiment is, excluding the shape of flange portion 26 of horn 2 (plate member 23), similar to that put forth in the seventh embodiment. FIGS. 9a-9d are cross sectional views of flange portion 26 of horn 2 of this eighth embodiment. FIG. 9a illustrates extremity 261 of flange portion 26 as being formed to an approximate hemispherical shape. The propagation of standing waves, which can be generated from parasitic oscillation, is restricted due to the non-uniform thickness of plate member 23 at flange portion 26. Accordingly, ultrasonic oscillations at all frequencies are prevented at the region of plate member 23 adjacent to flange portion 26. Furthermore, flange portion 26 may be provided at multiple locations in plate member 23, as shown in FIG. 9a, and each flange portion 26 may be formed at a variant height, as shown in FIG. 9b, to establish a varying thickness of the thick portion of plate member 23.

FIG. 9c illustrates a configuration of flange portion 26 in which lower extremity 262 of flange portion 26 is chamfered in addition to upper extremity 261 being formed to an approximate hemispherical shape. FIG. 9d illustrates a configuration in which flange portion 26 is formed integral to vertical wall 29 of horn 2. Forming flange portion 26 integrally to wall 29 is a structure that can simplify the manufacture of horn 2 according to the ninth embodiment.

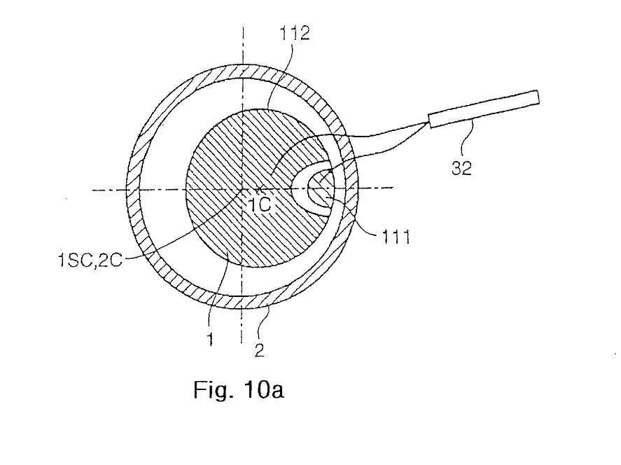

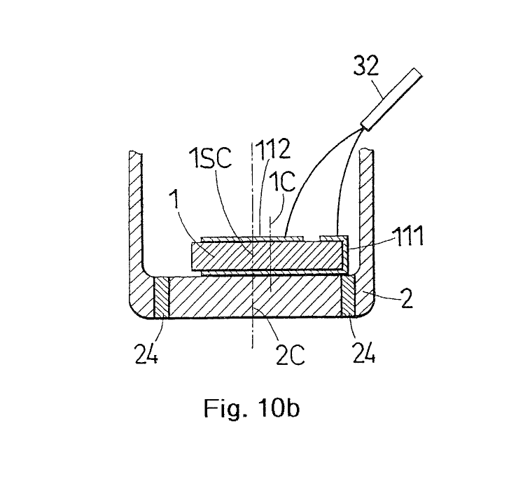

The structure of the ultrasonic cosmetic device of the present invention in a ninth embodiment is, excluding the shape of the electrodes of ultrasonic oscillator 1, essentially the same as that put forth in the first embodiment. However, in this ninth embodiment, ultrasonic oscillator 1 and horn 2 are joined so as to align the oscillating center of ultrasonic oscillator 1 and the center of horn 2. FIG. 10a is a plan view and FIG. 10b is a cross sectional view that illustrate the particular shape of the electrodes connected to ultrasonic oscillator 1 and the mutually joined positions of ultrasonic oscillator 1 and horn 2.

The electrodes of ultrasonic oscillator 1 are structured in the form of wrap-around lower electrode 111 and upper plate electrode 112. Because ultrasonic oscillator 1 does not oscillate in the overlapping electrode region, oscillating center 1SC of ultrasonic oscillator 1 is eccentrically aligned with material center 1C of the oscillator. Moreover, because oscillating center 1SC of ultrasonic oscillator 1 and center 2C of horn 2 are in alignment, center 2C of horn 2 is located at the point of maximum oscillation. When the ultrasonic cosmetic device is employed by the user, center 2C of horn 2 is placed in contact with skin 20 (see FIG. 16) to provide a highly efficient ultrasonic stimulation effect made possible by the point of maximum oscillation amplitude being placed in contact with skin 20.

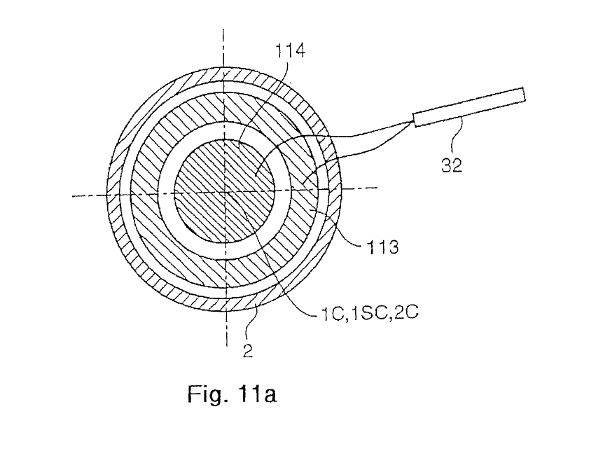

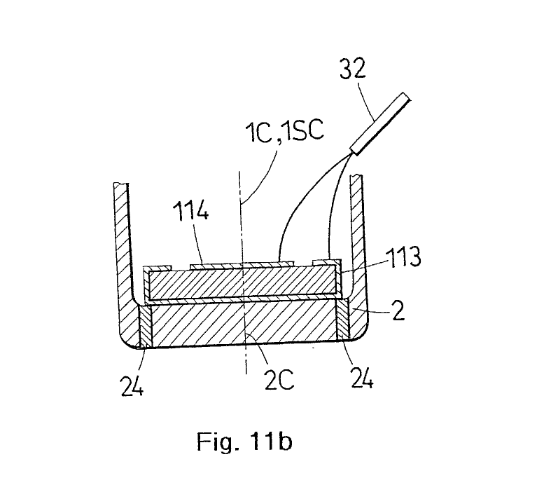

The structure of the ultrasonic cosmetic device of the present invention in a tenth embodiment is, excluding the shape of the electrodes of ultrasonic oscillator 1, essentially the same as that put forth in the first embodiment. However, in this tenth embodiment, ultrasonic oscillator 1 and horn 2 are mutually joined so as to align their respective centers. FIG. 11a is a plan view and FIG. 11b is a cross sectional view that illustrate the particular shape of the electrodes connected to ultrasonic oscillator 1 and the mutually joined positions of ultrasonic oscillator 1 and horn 2 according to the tenth embodiment.

The electrodes of ultrasonic oscillator 1 are structured in the form of upper electrode 114 and lower electrode 113. Lower electrode 113 includes a wrap-around portion that extends from the surface around the perimeter of upper electrode 114 to and over the lower surface of oscillator 1. While ultrasonic oscillator 1 does not oscillate in the region between the overlapping portions of lower electrode 113, electrode 113 is symmetrically formed in relation to the central axis of ultrasonic oscillator 1, thus aligning oscillating center 1SC of ultrasonic oscillator 1 with its dimensional center 1C. Moreover, because oscillating center 1SC of ultrasonic oscillator 1 and center 2C of horn 2 are in alignment, center 2C of horn 2 is located at the point of maximum oscillation. When the ultrasonic cosmetic device is employed by the user, center 2C of horn 2 is placed in contact with skin 20 (see FIG. 16) to provide a highly efficient ultrasonic stimulation effect made possible by the point of maximum oscillation amplitude being placed in contact with skin 20.

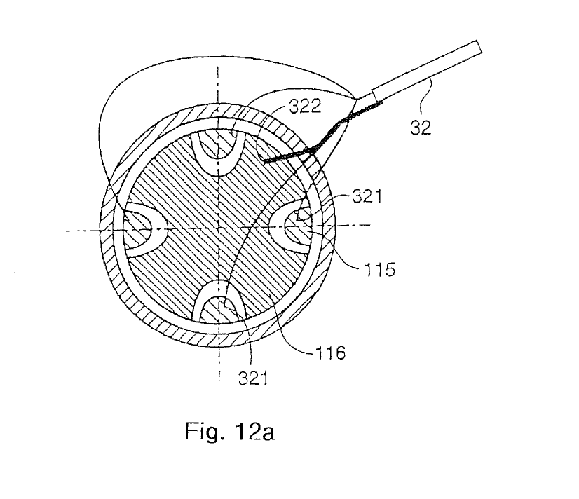

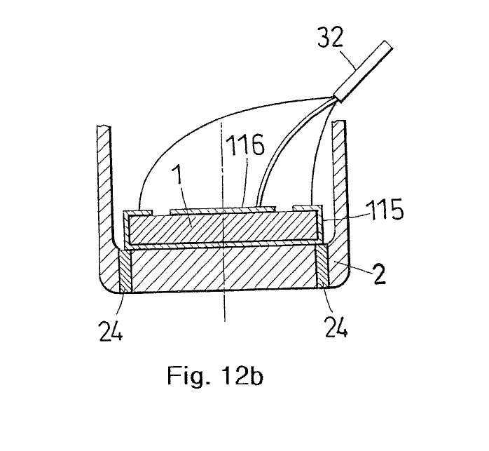

The structure of the ultrasonic cosmetic device of the present invention in an eleventh embodiment is, excluding the shape of the electrodes of ultrasonic oscillator 1, essentially the same as that put forth in the first embodiment. FIG. 12a is a plan view and FIG. 12b is a cross sectional view that illustrate the particular shape of the electrodes connected to ultrasonic oscillator 1 and the locations of the connections between the electrodes and wire leads according to the eleventh embodiment.

The electrodes are formed on opposing sides of ultrasonic oscillator 1 in the thickness direction, and provide an electrode structure constructed of upper electrode 116 and lower electrode 115. Lower electrode 115 includes a wrap-around portion that extends from the upper electrode 116 surface to and over the lower surface of oscillator 1. Wire leads 32 are connected to lower electrode 115 at connection points 321, and to upper electrode 116 at connection point 322. Because electrodes 115 and 116, wire leads 32, and connection points 321 and 322 are located at the outer perimeter of ultrasonic oscillator 1, ultrasonic oscillation amplitude is relatively small where the lead wires attach to connection points 321 and 322, thus forming a mechanism that reduces the possibility of the lead wires separating from connection points 321 and 322.

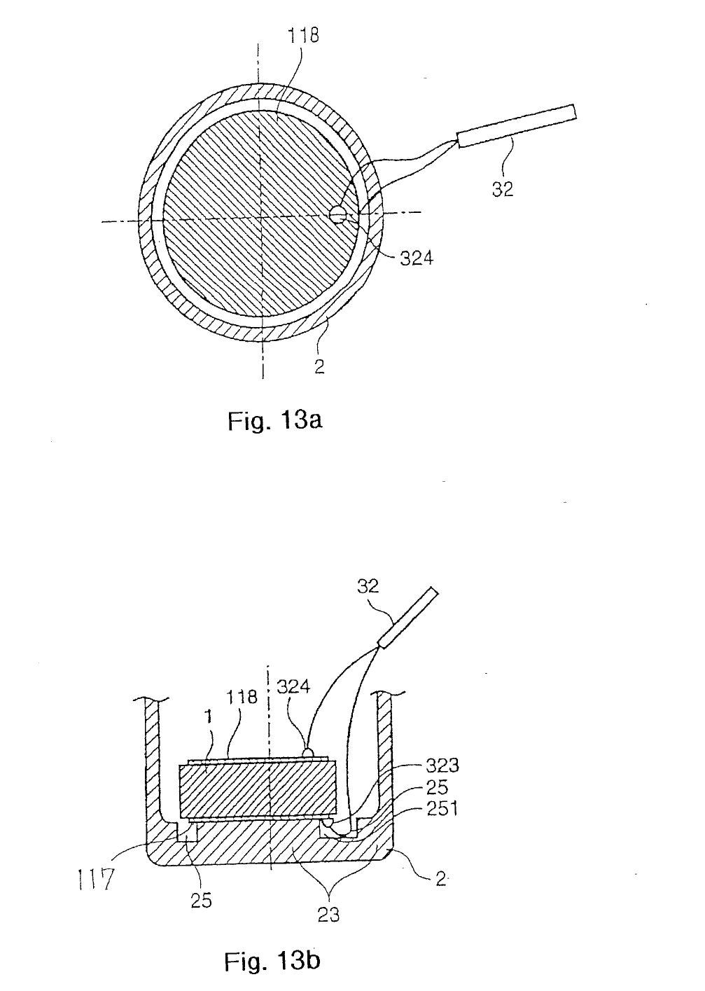

The structure of the ultrasonic cosmetic device of the present invention in a twelfth embodiment is, excluding the shape of the electrodes and channel portion 25, essentially similar to the structure put forth in the first embodiment. FIG. 13a is a plan view and FIG. 13b is a cross sectional view that illustrate the particular shape of the electrodes connected to ultrasonic oscillator 1 and the locations of their wire lead connection points according to the twelfth embodiment.

Two plate-type electrodes, lower electrode 117 and upper electrode 118, are formed on opposing sides of ultrasonic oscillator 1 in the thickness direction. Wire leads 32 are connected to lower electrode 117 at connection point 323, and to upper electrode 118 at connection point 324. In this embodiment, lower electrode 117 need not be formed as the previously mentioned wrap-around type electrode because wire lead connection point 323 is located on lower electrode 117 within electrode installation channel portion 251 which is formed as an inward radial extension of channel portion 25 in horn 2 (plate member 23). If a wrap-around type of electrode were employed (see FIGS. 10-12), there would be no ultrasonic oscillation generated at the area between the overlapping portions of the electrode. Comparing the wrap-around electrode structure with that of the opposing plate-type electrodes (lower electrode 117 and upper electrode 118) described in this twelfth embodiment, this opposing plate-type electrode structure provides the largest effective oscillation surface area.

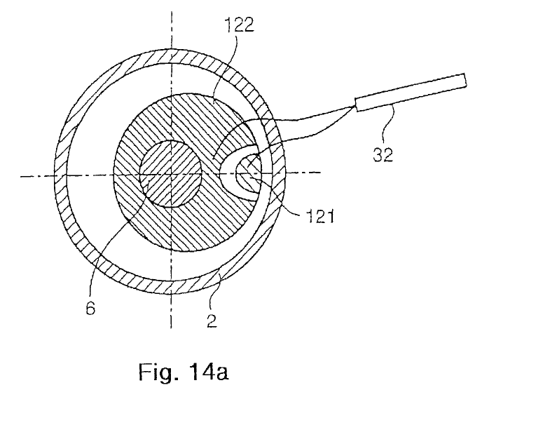

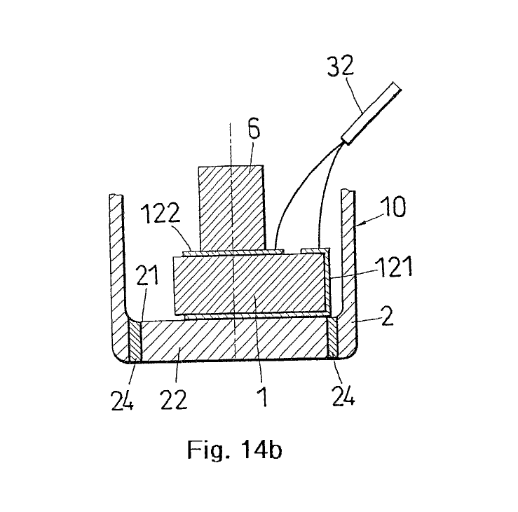

The structure of the ultrasonic cosmetic device of the present invention in a thirteenth embodiment is, excluding the previously mentioned damper piece attached to oscillating portion 10, essentially similar to the structure put forth in the ninth embodiment. FIG. 14a is a plan view and FIG. 14b is a cross sectional view that illustrate the shape of oscillating portion 10 included in this thirteenth embodiment.

Oscillating portion 10 includes horn 2 that is joined to ultrasonic oscillator 1 at joint surface 21, radiation surface 22 that is placed in contact with skin 20 (see FIG. 16), and damper piece 6 that is attached to ultrasonic oscillator 1 at the surface opposite to joint surface 21. Because damper piece 6 restricts ultrasonic oscillation emanating from the side of oscillator 1 in contact with the damper piece, oscillation is concentrated within horn 2 and thus oscillation efficiency is increased.

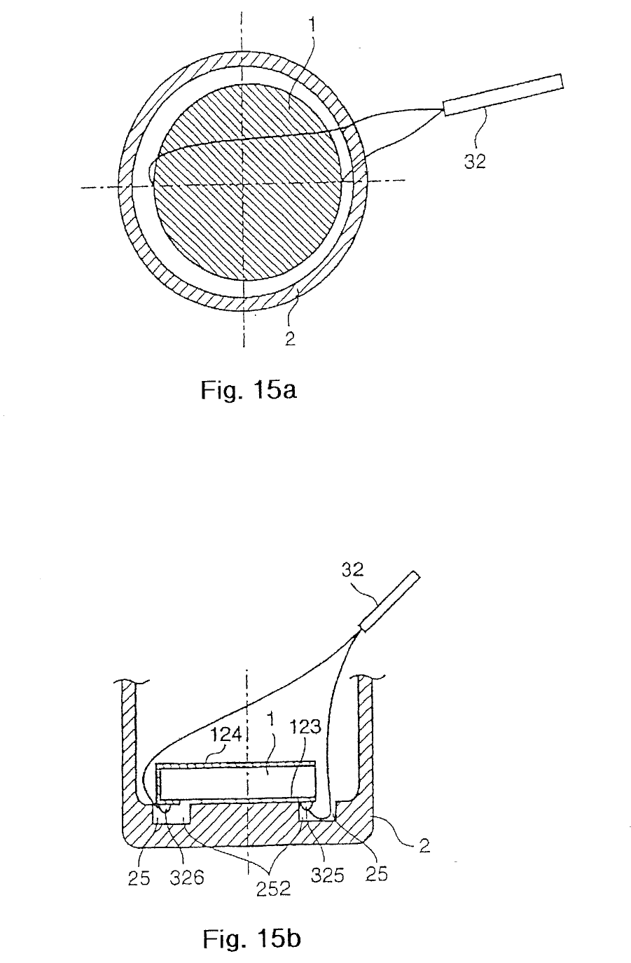

The structure of the ultrasonic cosmetic device of the present invention in a fourteenth embodiment is, excluding the shape of the electrodes of ultrasonic oscillator 1, essentially similar to the structure put forth in the twelfth embodiment. FIG. 15a is a plan view and FIG. 15b is a cross sectional view that illustrate the particular shape of the electrodes attached to ultrasonic oscillator 1 and the locations of their wire lead connection points.

Two electrodes, lower plate-type electrode 123 and upper electrode 124 are formed on opposing sides of ultrasonic oscillator 1 in the thickness direction. Upper electrode 124 is structured as a wrap-around electrode that extends from the lower electrode 123 surface to and over the opposing upper surface of the ultrasonic oscillator. Wire leads 32 are connected to lower electrode 123 at connection point 325, and to upper electrode 124 at connection point 326. Connection points 325 and 326 are located within electrode installation channel 252 which is formed as an inward extension of channel portion 25 in the radial direction within horn 2 (plate member 23). This configuration eliminates certain design restrictions for the device which would otherwise have to be considered if a lead wire were attached to the upper surface of ultrasonic oscillator 1. This configuration also allows oscillator portion 10 to be made to a thinner dimension and the ultrasonic cosmetic device to be made to a more compact size.

The present invention provides a restrictor portion installed around the external perimeter of an ultrasonic oscillator that restricts the outward propagation of ultrasonic waves in the radial direction, the result being that the horn can be more easily fabricated, without the need for a highly specific shape, and still offer a parasitic oscillation restriction property. This structure provides for increased ultrasonic oscillation propagation efficiency.

The present invention also provides a restrictor portion made from a material having an ultrasonic wave propagation restriction characteristic (for example, a material that absorbs or reflects ultrasonic waves), thus restricting the outward propagation of ultrasonic waves in the radial direction and eliminating parasitic oscillation.

The present invention establishes the thickness of the ultrasonic oscillator as a dimension approximately the product of an integer times half the ultrasonic wave length propagated within the ultrasonic oscillator, thus providing a mechanism to propagate the formation of standing ultrasonic waves within the ultrasonic oscillator. By establishing the thickness of the horn as a dimension approximately the product of an integer times half of the ultrasonic wave length, ultrasonic standing waves are formed in the horn with a resulting increase in ultrasonic wave propagation efficiency.

The present invention generates a longitudinal oscillation frequency in the thickness direction of the ultrasonic oscillator and horn, and in doing so causes the ultrasonic oscillator and horn to longitudinally oscillate in their thickness direction, thus increasing ultrasonic wave propagation efficiency.

The present invention provides a structure whereby the horn includes a joint surface and radiating surface that simplify manufacture of the horn.

The present invention provides a horn that incorporates an annular vertical wall, located around a flat plate member, that allows the horn to be secured to the housing without restricting ultrasonic oscillations at the plate member when the user is gripping the housing and holding the horn in contact with the skin.

The present invention provides at least one channel portion that forms a thin wall portion within the horn as means of raising resonant frequencies in the thin wall portion to restrict the propagation of ultrasonic frequencies within the plate member. By establishing the thickness of the thin wall portion to prevent the passage of ultrasonic frequencies whose wave length is approximately the product of an integer times one fourth the wave length of the waves in the plate member, it also becomes possible to restrict the propagation of ultrasonic harmonics.

The present invention provides at least one channel portion whose extremity is formed to an approximate hemispherical shape, thus establishing the thin wall portion to a non-uniform thickness where standing waves are unable to form, and thus forming a mechanism that restricts the propagation of all ultrasonic oscillating frequencies at the thin wall portion.

The present invention provides a channel portion filled with a material whose acoustic impedance characteristic is different than that of the horn material, thus restricting the propagation of ultrasonic waves from the ultrasonic oscillator at the thin wall portion, and providing the further benefit of preventing foreign objects, that may aid the propagation of ultrasonic oscillation, from invading the channel portion.

The present invention provides a restrictor portion formed as a flange portion extending from the joint surface as a thick wall portion that is able to lower resonant frequencies and restrict the propagation of ultrasonic oscillation. Also, the thick wall portion is formed to a thickness dimension able to prevent the passage of ultrasonic frequencies that are approximately the product of an integer times one fourth the wave length of ultrasonic waves in the thick wall portion, thus also restricting the propagation of ultrasonic harmonics.

The present invention provides a flange portion whose extremity is formed to an approximate hemispherical shape, thus establishing a non-uniform thickness at a specific region of the thick wall portion that eliminates the formation of standing waves. The result is a mechanism that restricts the propagation of all ultrasonic frequencies.

The present invention provides a horn that includes a vertical annular wall extending from the circumference of the plate member, thus establishing a structure through which the horn can be secured to the housing without restricting ultrasonic oscillations at the plate member at the time when the user is gripping the housing and holding the horn in contact with the skin. Moreover, the horn is easily fabricated as a result of the flange portion and vertical annular wall being formed as an integrated one-piece structure.

The present invention establishes the oscillating enter of the ultrasonic oscillator and the center of the horn in approximate mutual alignment, thus providing a mechanism through which oscillation amplitude is maximized at the center of the horn. Because the user operates the ultrasonic cosmetic device by bringing the center of the horn into contact with the skin, this structure makes it possible to efficiently apply ultrasonic stimulation to the skin.

The present invention provides electrodes located on the surfaces of the ultrasonic oscillator that oppose the oscillator thickness direction, to supply the oscillator with electrical power, through wire leads, from a drive device, whereby one electrode incorporates a wrap-around portion that extends and bends around the ultrasonic oscillator over opposing oscillator surfaces and over the center of the ultrasonic oscillator. Because the center of the ultrasonic oscillator and center of the horn are in approximate mutual alignment, the oscillating center of the ultrasonic oscillator and center of the horn are in approximate mutual alignment, thus forming a structure, similar to the structure in the thirteenth claim, that is able to efficiently apply ultrasonic stimulation to the skin.

The present invention provides a structure in which the connections between the electrodes and wire leads are located in the outer circumferential region of the ultrasonic oscillator, thus locating the connections at a region of reduced oscillation amplitude to prevent the separation of the wire leads from the electrodes.

The present invention provides a structure through which a wire lead is connected to an electrode at a location adjacent to a channel formed as an inward radial extension of an annular channel portion, thus eliminating the need for a wrap-around type of electrode. If a wrap-around type of electrode were to be employed with this type of wire lead connective structure, there would be no generation of ultrasonic oscillations in the oscillator region between the wrap-around portions of the electrode. Compared to a wrap-around electrode, this electrode structure is able to increase the effective oscillation surface area of the ultrasonic oscillator.

The present invention provides a damper piece fixedly installed to the ultrasonic oscillator on the side of the oscillator opposing the horn contact side, thus forming a mechanism through which ultrasonic oscillation is restricted at the damper piece side of the oscillator. As a result, the propagation of ultrasonic oscillation from the ultrasonic oscillator are concentrated on the horn side to increase oscillation efficiency.

The present invention provides one electrode to be formed as a wrap-around electrode that extends from one electrode surface and bends around the oscillator to the other, and for connection points between the electrode and wire lead to be located adjacent to the inner wall of a channel extending radially inward from the annular concave portion, thus locating both electrode connection points on the joint surface side of the ultrasonic oscillator and thereby making it possible to reduce the thickness of the oscillator and make the ultrasonic cosmetic device to more compact dimensions.

Although the invention has been described with reference to an exemplary embodiment, it is understood that the words that have been used are words of description and illustration, rather than words of limitation. Changes may be made within the purview of the appended claims, as presently stated and as amended, without departing from the scope and spirit of the invention in its aspects. Although the invention has been described with reference to particular means, materials and embodiments, the invention is not intended to be limited to the particulars disclosed. Rather, the invention extends to all functionally equivalent structures, methods, and uses such as are within the scope of the appended claims.

The present disclosure relates to subject matter contained in priority Japanese Application No. 2001-225555, filed on Jul. 26, 2001, which is herein expressly incorporated by reference in its entirety.

What is claimed is:

1. An ultrasonic cosmetic device including:
an ultrasonic oscillator having a thickness at an ultrasonic wave generating region;
a horn that provides ultrasonic waves from a [wave] radiating surface;
a probe having an oscillating portion including said horn, said horn being connected to said ultrasonic oscillator through a joint surface; and
a drive device that drives said ultrasonic oscillator;
wherein said horn includes a restrictor portion located outside of a circumference of said ultrasonic oscillator, said restrictor portion including an external circumferential component and restricting propagation of ultrasonic waves in the radial direction.

2. The ultrasonic cosmetic device according to claim 1, wherein said restrictor portion is constructed of a material that has ultrasonic wave propagation restriction properties.

3. The ultrasonic cosmetic device according to claim 1, wherein the thickness of said ultrasonic oscillator is approximately the product of an integer times half the ultrasonic wave length propagated in the ultrasonic oscillator, and the thickness of said horn is approximately the product of an integer times half the ultrasonic wave length propagated in the horn.

4. The ultrasonic cosmetic device according to claim 1, wherein said drive device generates a longitudinal oscillation frequency in the thickness direction of said ultrasonic oscillator and said horn.

5. The ultrasonic cosmetic device according to claim 1, wherein the said horn includes a flat plate member including said joint surface and said radiating surface.

6. The ultrasonic cosmetic device according to claim 1, wherein said horn includes a flat plate member including said joint surface, a radiating surface, and an annular vertical wall formed at an outer circumferential region of said flat plate member.

7. The ultrasonic cosmetic device according to claim 1, wherein said restrictor portion is configured as a thin wall portion formed by a channel portion provided on said horn.

8. The ultrasonic cosmetic device according to claim 7, wherein an edge of said channel portion is shaped as an approximate hemisphere.

9. The ultrasonic device according to claim 7, wherein said channel portion is filled with a material having an acoustic impedance characteristic different from that of the horn material.

10. The ultrasonic cosmetic device according to claim 1, wherein said restrictor portion is configured as a thick wall portion created by a flange portion formed on said joint surface.

11. The ultrasonic cosmetic device according to claim 10, wherein an edge of said flange portion is formed in an approximate hemispherical shape.

12. The ultrasonic cosmetic device according to claim 10, wherein said horn includes a flat plate member having a joint surface and said radiating surface, and includes said flange portion formed as an integral portion of said thick wall portion located around the circumference of the flat plate member.

13. The ultrasonic cosmetic device according to claim 1, wherein the oscillation center of said ultrasonic oscillator and the center of said horn are in approximate alignment.

14. The ultrasonic cosmetic device according to claim 1, wherein the center of said ultrasonic oscillator and the center of said horn are in approximate alignment, electrodes are provided on opposing electrode surfaces of said ultrasonic oscillator in the thickness direction to supply the oscillator with electrical power through wire leads from said drive device, and one electrode is formed as a wrap-around electrode including a wrap-around portion that extends from one electrode surface to another opposing electrode surface, and which is symmetrically shaped in relation to the central axis of said oscillator.

15. The ultrasonic cosmetic device according to claim 14, wherein connections between said electrodes and lead wires are located in an outer circumferential region of said ultrasonic oscillator.

16. The ultrasonic cosmetic device according to claim 7, wherein electrodes are provided on opposing surfaces of said ultrasonic oscillator in the thickness direction to supply said oscillator with electrical power through lead wires, and connecting points between said electrodes and wire leads are located adjacent to an inner wall of a channel connecting to and extending radially inward from said annular channel portion.

17. The ultrasonic cosmetic device according to claim 1, wherein a damper is fixed to said ultrasonic oscillator on a side of said oscillator opposite to said horn joint surface side.

18. The ultrasonic cosmetic device according to claim 7, wherein electrodes are formed on oscillator surfaces opposing the thickness direction of said ultrasonic oscillator to supply the oscillator with electrical power through lead wires from a drive device, and wherein one electrode includes a wrap-around electrode that extends from one electrode surface to another, and wherein connections between said electrodes and wire leads are located adjacent to an inner wall of a channel connecting to and extending radially inward from said annular channel portion.
